(19) United States
(12) Patent Application Publication
(10) Pub. No.: US 2026/0066424 A1
(43) Pub. Date: Mar. 5, 2026

(54) TRACTION BATTERY PACK THERMAL BARRIER

(71) Applicant: Ford Global Technologies, LLC, Dearborn, MI (US)

(72) Inventor: Xiaogang Zhang, Novi, MI (US)

(21) Appl. No.: 18/820,663

(22) Filed: Aug. 30, 2024

(51) Int. Cl. H01M 50/242; B60L 50/64; H01M 10/0525; H01M 10/613; H01M 10/625; H01M 10/6567; H01M 10/658; H01M 50/209; H01M 50/293

(52) U.S. Cl. CPC H01M 50/242; B60L 50/64; H01M 10/0525; H01M 10/613; H01M 10/625; H01M 10/6567; H01M 10/658; H01M 50/209; H01M 50/293; H01M 2220/20

(57) ABSTRACT

A traction battery pack assembly includes a cell stack within an interior of an enclosure. The cell stack has a plurality of battery cells disposed along a cell stack axis and at least one thermal barrier disposed along the cell stack axis. The at least one thermal barrier has a plurality of more compressible pieces secured to a plurality of less compressible pieces to establish at least one channel that is configured to communicate a liquid coolant though the cell stack.

### TECHNICAL FIELD

This disclosure details exemplary assemblies that guide liquid coolant within a battery pack and, more particularly, to a thermal barriers that guide the liquid coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a cell stack within an interior of an enclosure, the cell stack including a plurality of battery cells disposed along a cell stack axis and at least one thermal barrier disposed along the cell stack axis, the at least one thermal barrier having a plurality of more compressible pieces secured to a plurality of less compressible pieces to establish at least one channel configured to communicate a liquid coolant though the cell stack.

In some aspects, the techniques described herein relate to an assembly, wherein the at least one channel opens to a first side of the cell stack and to an opposite second side of the cell stack.

In some aspects, the techniques described herein relate to an assembly, wherein the at least one channel has a rectangular cross-section.

In some aspects, the techniques described herein relate to an assembly, wherein the first side is a first horizontal side, and the second side is a second horizontal side.

In some aspects, the techniques described herein relate to an assembly, wherein the at least one channel is disposed between axially adjacent battery cells within the plurality of battery cells.

In some aspects, the techniques described herein relate to an assembly, wherein the at least one thermal barrier is compressible.

In some aspects, the techniques described herein relate to an assembly, wherein the plurality of more compressible pieces are a plurality of foam pieces.

In some aspects, the techniques described herein relate to an assembly, wherein the plurality of less compressible pieces are a plurality of metallic pieces.

In some aspects, the techniques described herein relate to an assembly, the plurality of metallic pieces are a plurality of aluminum pieces.

In some aspects, the techniques described herein relate to an assembly, wherein the plurality of less compressible pieces provide at least two sides of a liquid coolant channel through the cell stack, and the plurality of more compressible pieces provide at least two other sides of the liquid coolant channel.

In some aspects, the techniques described herein relate to an assembly, wherein the plurality of less compressible pieces provide opposing horizontal sides of the liquid coolant channel, wherein the plurality of more compressible pieces provide opposing vertical sides of the liquid coolant channel.

In some aspects, the techniques described herein relate to an assembly, wherein the plurality of more compressible pieces each include portions that are sandwiched between two of the less compressible pieces within the plurality of less compressible pieces.

In some aspects, the techniques described herein relate to an assembly, wherein the plurality of more compressible pieces are secured to the plurality of less compressible pieces using an adhesive.

In some aspects, the techniques described herein relate to an assembly, wherein the plurality of more compressible pieces are a plurality of foam bars, and the plurality of less compressible pieces are a plurality of metallic bars.

In some aspects, the techniques described herein relate to an assembly, wherein the cell stack is one of a plurality of cell stacks within the interior.

In some aspects, the techniques described herein relate to an assembly, wherein the liquid coolant is a dielectric liquid coolant.

In some aspects, the techniques described herein relate to a traction battery pack assembly, including: at least one first battery cell of a cell stack; at least one second battery cell of the cell stack; and a thermal barrier assembly of the cell stack, the thermal barrier assembly disposed axially between the at least one first battery cell and the at least one second battery cell, the thermal barrier assembly including a plurality of foam pieces sandwiched between a plurality of first metallic pieces and a plurality of second metallic pieces, the thermal barrier assembly configured guide a liquid coolant through the cell stack between the at least one first battery cell and the at least one second battery cell.

In some aspects, the techniques described herein relate to a traction battery pack assembly, wherein the thermal barrier assembly establishes at least one liquid coolant channel.

In some aspects, the techniques described herein relate to a traction battery pack assembly, wherein the plurality of foam pieces and the plurality of metallic pieces establish the at least one liquid coolant channel.

In some aspects, the techniques described herein relate to a traction battery pack assembly, wherein each of the plurality of metallic pieces is bonded two of the foam pieces in the plurality of foam pieces.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates a side view of a portion of the battery pack of FIG. 2 showing a portion of a cell stack disposed between an enclosure cover and an enclosure tray.

FIG. 4 illustrates a perspective view of a thermal barrier from the cell stack of FIG. 3.

FIG. 5 illustrates an end view of the thermal barrier of FIG. 4

FIG. 6 illustrates an expanded view of the thermal barrier of FIG. 4.

### DETAILED DESCRIPTION

An immersion thermal management system can be used to manage thermal energy in a traction battery pack. In such a traction battery pack, at least some components of the traction battery pack are immersed in a liquid coolant. The immersed components can include a cell stack.

This disclosure is directed toward guiding the liquid coolant through the cell stack using channels that are provided by a compressible barrier. During operation, cells may swell. That the thermal barrier is compressible allows the thermal barrier to accommodate this swelling.

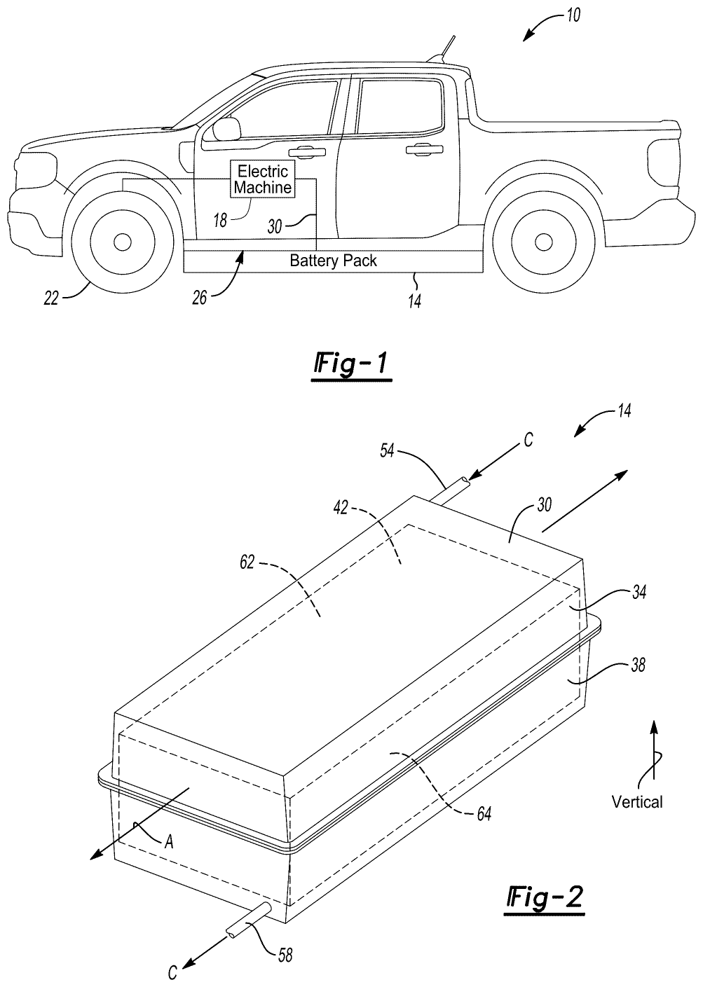

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

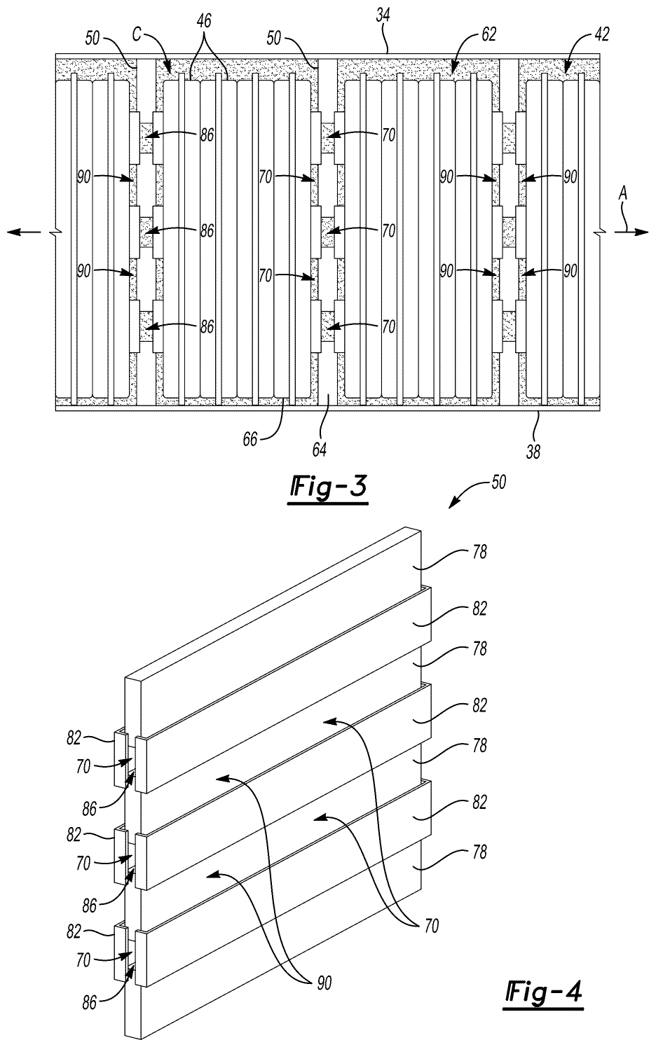

FIGS. 2 and 3 illustrates additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of thermal barriers 50. Each of the thermal barriers 50 can be sandwiched between two of the battery cells 46 along the cell stack axis.

The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 and thermal barriers 50 of FIG. 3 are positioned side-by-side relative to one another, other configurations are also contemplated within the scope of this disclosure, including but not limited to embodiments in which the battery cells 46 and thermal barriers 50 are stacked on top of one another, for example.

In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery pack 14. The example thermal management system is configured to route non-conductive (i.e., dielectric) coolant C over areas of the cell stack 42 to manage thermal energy within the cell stack 42 by, for example, using the coolant C to take on heat from the cell stack 42. the thermal management system is an immersion thermal management system at least because portions of the battery pack 14, here at least the battery cells 46 of the cell stack 42 are immersed in the coolant C.

In this example, the coolant C generally flows from an inlet 54, which is formed in the cover 34, to an outlet 58, which is formed in the tray 38 at an opposite end of the enclosure assembly 30 from the inlet 54.

The cell stack 42 has a top side 62, opposing outboard sides 64, and a bottom side 66. Within the interior of the enclosure assembly 30, some of the coolant C communicates through the cell stack 42 in-between the battery cells 46 through at least one channel 70 established by the thermal barriers 50. Thermal energy can transfer between the coolant and the battery cells 46 as the coolant C moves through the at least one channel 70 between the battery cells 46.

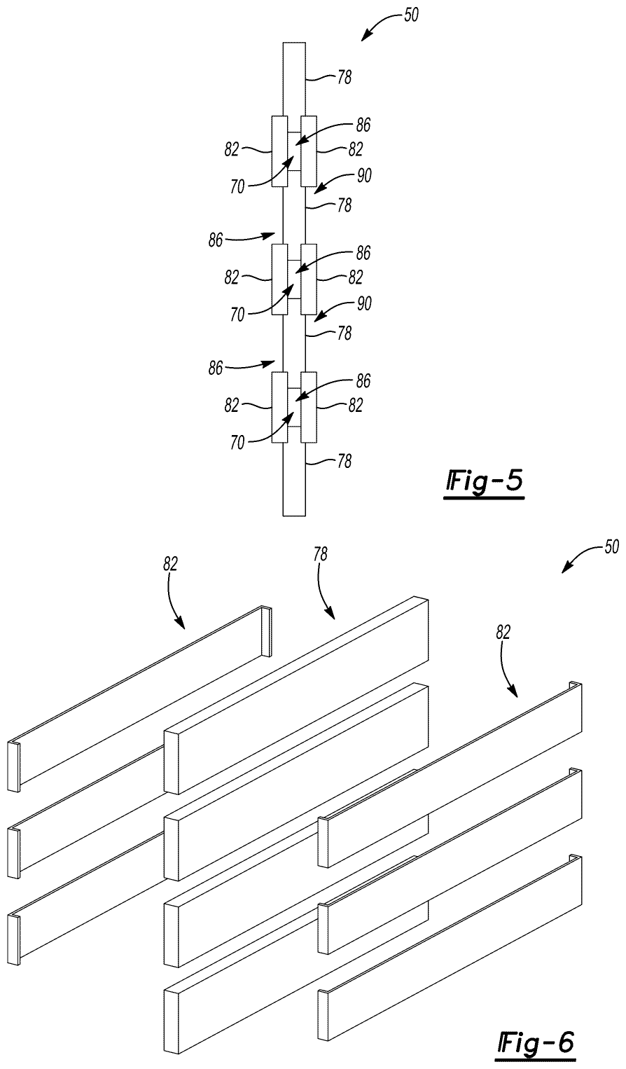

With reference now to FIG. 4-6 and continuing reference to FIGS. 2 and 3, the example thermal barriers 50 include a plurality of more compressible pieces 78 and a plurality of less compressible pieces 82. The thermal barriers 50 can each be positioned between axially adjacent cells 46 of the cell stack 42.

The more compressible pieces 78 are vertically offset from the less compressible pieces 82. The more compressible pieces 78 vertically overlap the less compressible pieces 82 by about 2 millimeters in this example. Each of the less compressible pieces 82 is, in this example, is secured to two of the more compressible pieces 78. The more compressible pieces 78 are sandwiched between less compressible pieces 82 on a first axial side, and less compressible pieces 82 on an opposite, second axial side.

The more compressible pieces 78 can be foam, such as a polymer-based foam. The less compressible pieces 82 can be metallic material, such as aluminum. The more compressible pieces 78 and the less compressible pieces 82 are bars and have rectangular cross-sections in this example. The more compressible pieces 78 are 10 millimeters tall and three millimeters wide in this example, and the less compressible pieces 82 are 8 millimeters tall and 1.5 millimeters wide.

The uppermost more compressible piece 78 contacts an underside of the enclosure cover 34 and is bonded to two of the less compressible pieces 82. The lowermost more compressible piece 78 contacts a floor of the enclosure tray 38 and is bonded to two of the less compressible pieces 82. The remaining more compressible pieces 78 are bonded to four of the less compressible pieces 82. Adhesive can be used to bond together the less compressible pieces 82 and the more compressible pieces 78. When installed within the battery pack 14, the cell stack 42 can be compressed along the cell stack axis A, which can slightly compress the more compressible pieces 78 at the corners of the more compressible pieces 78. The more compressible pieces 78 are compressed 0.5 millimeters by each of the less compressible pieces 82 in this example.

At the top and bottom of the cell stack 42, contact between the thermal barrier 50 and the enclosure assembly 30 can help to compartmentalize vent byproducts within areas of the interior of the battery pack 14 during, for example, a thermal event where one or more of the battery cells 46 is venting. The vent byproducts are vented from the battery cells 46 into the liquid coolant and are then directed laterally outward rather than along the cell stack axis A.

In this example, the thermal barriers 50 each include four of the more compressible pieces 78 sandwiched between three of the less compressible pieces on a first axial side, and three of the less compressible pieces on an opposite, second axial side.

The at least one channel 70 of the example thermal barriers 50 includes three channels 86 having a circumferential perimeter established entirely by the thermal barrier 50. The channels 86 open to the opposing outboard sides of the cell stack 42 and to the second side of the cell stack 42. The channels 86 extend through the cell stack 42. The liquid coolant introduced through the inlet 54 can communicate through the channels 86 and thus communicate through the cell stack 42.

In another example, one or more the thermal barriers 50 could be rotated with the cell stack 42 about the cell stack axis A so that the channels 70 extend vertically rather than horizontally.

The example channels 86 have a rectangular cross-section. The more compressible pieces 78 establish top and bottom sides of the channels 86. The less compressible pieces 82 establish opposing horizontal sides of the channels 86. Other numbers of more compressible pieces 78 and less compressible pieces 82 could be used to establish more than three channels 86 or less than three channels 86.

The liquid coolant can also communicate through the cell stack 42 through channels 90, which have perimeters established on the top and bottom by the less compressible pieces 82, on one horizontal side by one of the more compressible pieces 78, and on the other horizontal side by one of the battery cells 46.

Features of disclosed examples include a thermal barrier that provides space for flow of a coolant between cells, and that guides flow moving between cells. The thermal barrier can be provided by a plurality of bars—some more compressive than others. Using bars can facilitate manufacturability. Sheets of material, such as mica sheets of material, may not be required.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack within an interior of an enclosure, the cell stack including a plurality of battery cells disposed along a cell stack axis and at least one thermal barrier disposed along the cell stack axis, the at least one thermal barrier having a plurality of more compressible pieces secured to a plurality of less compressible pieces to establish at least one channel configured to communicate a liquid coolant though the cell stack.

2. The assembly of claim 1, wherein the at least one channel opens to a first side of the cell stack and to an opposite second side of the cell stack.

3. The assembly of claim 2, wherein the at least one channel has a rectangular cross-section.

4. The assembly of claim 2, wherein the first side is a first horizontal side, and the second side is a second horizontal side.

5. The assembly of claim 2, wherein the at least one channel is disposed between axially adjacent battery cells within the plurality of battery cells.

6. The assembly of claim 1, wherein the at least one thermal barrier is compressible.

7. The assembly of claim 6, wherein the plurality of more compressible pieces are a plurality of foam pieces.

8. The assembly of claim 7, wherein the plurality of less compressible pieces are a plurality of metallic pieces.

9. The assembly of claim 8, wherein the plurality of metallic pieces are a plurality of aluminum pieces.

10. The assembly of claim 1, wherein the plurality of less compressible pieces provide at least two sides of a liquid coolant channel through the cell stack, and the plurality of more compressible pieces provide at least two other sides of the liquid coolant channel.

11. The assembly of claim 10, wherein the plurality of less compressible pieces provide opposing horizontal sides of the liquid coolant channel, wherein the plurality of more compressible pieces provide opposing vertical sides of the liquid coolant channel.

12. The assembly of claim 7, wherein the plurality of more compressible pieces each include portions that are sandwiched between two of the less compressible pieces within the plurality of less compressible pieces.

13. The assembly of claim 7, wherein the plurality of more compressible pieces are secured to the plurality of less compressible pieces using an adhesive.

14. The assembly of claim 7, wherein the plurality of more compressible pieces are a plurality of foam bars, and the plurality of less compressible pieces are a plurality of metallic bars.

15. The assembly of claim 1, wherein the cell stack is one of a plurality of cell stacks within the interior.

16. The assembly of claim 1, wherein the liquid coolant is a dielectric liquid coolant.

17. A traction battery pack assembly, comprising:
at least one first battery cell of a cell stack;
at least one second battery cell of the cell stack; and
a thermal barrier assembly of the cell stack, the thermal barrier assembly disposed axially between the at least one first battery cell and the at least one second battery cell, the thermal barrier assembly including a plurality of foam pieces sandwiched between a plurality of first metallic pieces and a plurality of second metallic pieces, the thermal barrier assembly configured guide a liquid coolant through the cell stack between the at least one first battery cell and the at least one second battery cell.

18. The traction battery pack assembly of claim 17, wherein the thermal barrier assembly establishes at least one liquid coolant channel.

19. The traction battery pack assembly of claim 18, wherein the plurality of foam pieces and the plurality of metallic pieces establish the at least one liquid coolant channel.

20. The traction battery pack assembly of claim 17, wherein each of the plurality of metallic pieces is bonded two of the foam pieces in the plurality of foam pieces.
